(19) United States
(12) Patent Application Publication
(10) Pub. No.: US 2008/0271507 A1
(43) Pub. Date: Nov. 6, 2008

(54) BUMP RESISTANT PIN TUMBLER LOCK

(76) Inventor: Jonathon Hocut, San Francisco, CA (US)

Correspondence Address: HAYNES BEFFEL & WOLFELD LLP, P O BOX 366, HALF MOON BAY, CA, 94019, US

(21) Appl. No.: 12/113,473

(22) Filed: May 1, 2008

Related U.S. Application Data
(60) Provisional application No. 60/927,942, filed on May 3, 2007.
(60) Provisional application No. 61/036,342, filed on Mar. 13, 2008.

(51) Int. Cl. E05B 27/00

(52) U.S. Cl. 70/493

(57) ABSTRACT

Methods and apparatus for improving bump resistance in pin tumbler locks include, in various embodiments, means provided within a tumbler passage for preventing or inhibiting the formation of a gap between a key pin and a drive pin. In a pin tumbler lock at least one passage contains damped biasing means operable to urge the pin set toward a key opening or keyway. In a pin tumbler lock at least one pin set includes a key pin, a drive pin, and a dummy pin, in which the key pin and the drive pin are dimensioned so that when the lock is at rest the drive pin crosses the shear line. Also, methods for improving attack resistance of pin tumbler locks include replacing a spring in a passage with damped biasing means; or replacing a pin set with a pin set including a key pin, a drive pin, and a dummy pin, in which the key pin and the drive pin are dimensioned so that when the lock is at rest the drive pin crosses the shear line.

### CROSS-REFERENCE TO RELATED APPLICATIONS

This application claims priority from U.S. Provisional Application No. 60/927,942, filed May 3, 2007, titled “Cylinder lock with damped biasing springs”, and from U.S. Provisional Application No. 61/036,342, filed Mar. 13, 2008, titled “Bump resistant pin tumbler lock”, each of which is hereby incorporated herein by reference.

### BACKGROUND

This invention relates to improving the security of pin tumbler locks and, particularly, to improving the security of locks that are vulnerable to bump key or snap pick attack.

Pin tumbler locks are locks that depend for operation on tumblers composed of stacked pins biased against a spring, where the split lines of the pins are intended to line up with the shear line of the lock. Pin tumbler locks include but are not limited to the following two general types of cylinder locks.

In one type the cylinder plug is rotatable within a lock housing, and the tumblers, tumbler passages, and biasing springs are disposed generally radially of the fixed axis about which the cylinder plug is rotated from the locked to the unlocked position.

In another type the cylinder plug is in contact with a face surface of the housing, and rotates relative to the housing along a shear line defined by the contact surface. In this lock form the tumbler pins, tumbler passages, and damped biasing springs are disposed along axes extending longitudinally, i.e., parallel to the axis of rotation of the cylinder plug. This type of lock employs a tubular key, and the tumbler pins generally are arranged in a circular disposition about the axis of rotation of the cylinder plug.

Techniques for violating pin tumbler locks by bumping, or snapping, are well-known. The techniques generally work by inserting a tool into the keyway or key opening, and manipulating or operating the tool to transfer an impulse to the tumblers, causing a gap between adjacent pins to form at the shear line and applying a torque to open the lock during the brief interval before the springs close the gap.

A variety of tools are known to assist in attacking a pin tumbler lock in this manner. They include so-called “bump keys”, “snap picks”, “pick guns”, “snapper picks” and vibrating picks.

Various lock designs have been proposed as providing bump resistance. Typically these bump resistant designs are complex and require a complete manufacturing changeover; and they typically cost several times as much as conventional locks. Moreover, existing locks cannot be readily retrofitted to incorporate such designs.

### SUMMARY

In general the invention features methods and apparatus for improving bump resistance in pin tumbler locks. In various embodiments, means are provided within a tumbler passage for preventing or inhibiting the formation of a gap between a key pin and a drive pin.

In one general aspect the invention features a pin tumbler lock in which at least one pin set includes a key pin, a drive pin, and a dummy pin, the key pin and the drive pin being dimensioned so that when the lock is at rest the drive pin crosses the shear line.

In some such embodiments, to effect bump resistance, the relative masses of the pins are such that when momentum is imparted by the key pin to the drive pin, movement of the drive pin is limited so that the bottom end of the drive pin does not reach or pass the shear line, or—if the bottom end of the drive pin reaches or passes the shear line—it does so for such a short time interval that rotation of the cylinder plug is effectively blocked.

In some embodiments the mass of the dummy pin is at least as great as the greater of the mass of the key pin or the mass of the drive pin. That is, where the mass of the key pin is greater than the mass of the drive pin, the mass of the dummy pin is greater than or equal to the mass of the key pin; and, where the mass of the drive pin is greater than the mass of the key pin, the mass of the dummy pin is greater than or equal to the mass of the drive pin. In some embodiments the mass of each pin is equal to or greater than the pin below; that is, the mass of the key pin is less than or equal to the mass of the drive pin, which is less than or equal to the mass of the dummy pin.

A pin (such as the dummy pin) in the pin set may be made to have relatively greater mass than another pin in the pin set either by being larger (that is, by occupying more volume, for example by being longer), or by having a greater density (mass/volume), or by some combination of greater volume and greater density; the pin having relatively greater mass may from example be made of a material (such as an alloy) having greater density. Use of a higher density pin as the key pin and/or as the dummy pin can provide a pin set having an overall length comparable to that of a conventional lock, and including a key pin having the same length as in a conventional lock. This permits construction of a lock having a given keying combination without changing the length of the passage, by adding a dummy pin having a suitably high mass or by exchanging the conventional drive pin with a dummy pin and drive pin having suitable relative masses.

In another general aspect the invention features a pin tumbler lock in which at least one passage contains damped biasing means operable to urge the pin set toward a key opening or keyway.

In some such embodiments the damped biasing means includes a spring (or a device having a spring function) and a damper (or a device having a damping function), wherein the damper and spring are configured to act in the same direction. In some embodiments the spring and damper are next to each other, and operate in parallel, in other embodiments the spring and damper are in a row lengthwise the passage, and act in series. In some embodiments the spring is contained within the damper. In some embodiments the spring function and the damping function are supplied by the same device. In some embodiments the damped biasing means includes a miniature shock absorber; in some embodiments the damped biasing means includes an elastomer plug.

In another general aspect the invention features a kit for modification of a pin tumbler lock, the kit including at least one damped biasing means configured and dimensioned to operate within a passage of the lock.

In another general aspect the invention features a kit for modification of a pin tumbler lock, the kit including at least one pin set including a key pin, a drive pin, and a dummy pin, configured and dimensioned to operate within a passage of the lock, the key pin and the drive pin being dimensioned so that when the lock is at rest the drive pin crosses the shear line.

In another aspect the invention features a method for improving the resistance of pin tumbler lock to attack, by opening the lock as if to re-key the lock, and replacing the spring in at least one passage with damped biasing means.

In another aspect the invention features a method for improving the resistance of pin tumbler lock to attack, by opening the lock as if to re-key the lock, and replacing the drive pin with a substitute drive pin and a dummy pin. The substitute drive pin is dimensioned to traverse the shear line when at rest, and the masses of the drive pin and the dummy pin are selected so that at least some portion of the momentum imparted by the key pin to the drive pin during an attempt to bump the lock is passed to the dummy pin, inhibiting appearance of a gap between pins at the shear line.

The present invention provides many advantages over other locks that have been designed to resist bumping. The design according to the invention is simple to implement, so that lock manufacturers can incorporate the damped biasing springs without extensive alteration to the lock manufacturing line and with only a small increase in the cost of the components. Moreover, existing locks can be readily and inexpensively retrofitted according to the invention, by simply swapping out parts to provide the design according to the invention.

### BRIEF DESCRIPTION OF THE DRAWINGS

FIG. 1A is a diagrammatic sketch showing a conventional cylinder lock in one configuration in a transverse sectional view at the location indicated at A-A in FIG. 1B.

FIG. 1B is a diagrammatic sketch showing a conventional cylinder lock as in FIG. 1A in a lengthwise sectional view thru the axis of rotation of the cylinder at the location at B-B in FIG. 1A.

FIG. 2 is a diagrammatic sketch showing a conventional cylinder lock as in FIGS. 1A, 1B in a lengthwise sectional view, illustrating release of the lock by insertion of a properly cut key in the keyway.

FIGS. 3A and 3B are diagrammatic sketches showing a conventional cylinder lock as in FIGS. 1A and 1B, respectively, illustrating release of the lock by bumping.

FIG. 4A is a diagrammatic sketch showing an embodiment of a cylinder lock according to the invention in a transverse sectional view at the location indicated at A-A in FIG. 4B.

FIG. 4B is a diagrammatic sketch showing an embodiment of a cylinder lock according to the invention as in FIG. 4A in a lengthwise sectional view thru the axis of rotation of the cylinder at the location at B-B in FIG. 4A.

FIG. 5A is a diagrammatic sketch showing another embodiment of a cylinder lock according to the invention in a transverse sectional view at the location indicated at A-A in FIG. 5B.

FIG. 5B is a diagrammatic sketch showing another embodiment of a cylinder lock according to the invention as in FIG. 5A in a lengthwise sectional view thru the axis of rotation of the cylinder at the location at B-B in FIG. 5A.

FIG. 6 is a diagrammatic sketch showing an embodiment of a cylinder lock as in FIG. 5B in a lengthwise sectional view thru the axis of rotation of the cylinder, illustrating release of the lock by insertion of a properly cut key in the keyway.

FIGS. 7A and 7B are diagrammatic sketches showing an embodiment of a cylinder lock as in FIGS. 5A and 5B, respectively, illustrating a failure of bumping to release the lock.

FIG. 8 is a diagrammatic sketch showing a conventional cylinder lock in a second configuration in a lengthwise sectional view thru the axis of rotation of the cylinder.

FIG. 9 is a diagrammatic sketch showing a conventional cylinder lock as in FIG. 8, in a lengthwise sectional view thru the axis of rotation of the cylinder, illustrating release of the lock by insertion of a properly cut key in the keyway.

FIG. 10 is a diagrammatic sketch showing a conventional cylinder lock as in FIG. 8, in a lengthwise sectional view thru the axis of rotation of the cylinder, illustrating release of the lock by bumping.

FIG. 11 is a diagrammatic sketch showing an embodiment of a cylinder lock according to the invention in a lengthwise sectional view thru the axis of rotation of the cylinder.

FIG. 12 is a diagrammatic sketch showing another embodiment of a cylinder lock according to the invention in a lengthwise sectional view thru the axis of rotation of the cylinder.

FIG. 13 is a diagrammatic sketch showing an embodiment of a cylinder lock according to the invention in a lengthwise sectional view thru the axis of rotation of the cylinder as in FIG. 12, illustrating release of the lock by insertion of a properly cut key in the keyway.

FIG. 14 is a diagrammatic sketch showing an embodiment of a cylinder lock according to the invention in a lengthwise sectional view thru the axis of rotation of the cylinder as in FIG. 12, illustrating a failure of bumping to release the lock.

### DETAILED DESCRIPTION

The invention will now be described in further detail by reference to the drawings, which illustrate alternative embodiments of the invention. The drawings are diagrammatic, showing features of the invention and their relation to other features and structures, and are not made to scale. For improved clarity of presentation, in the FIGs. illustrating embodiments of the invention, elements corresponding to elements shown in other drawings are not all particularly renumbered, although they are all readily identifiable in all the FIGs. Also for clarity certain features are shown symbolically rather than pictorially. Also for clarity of presentation certain features are not shown in the FIGs., where not necessary for an understanding of the invention.

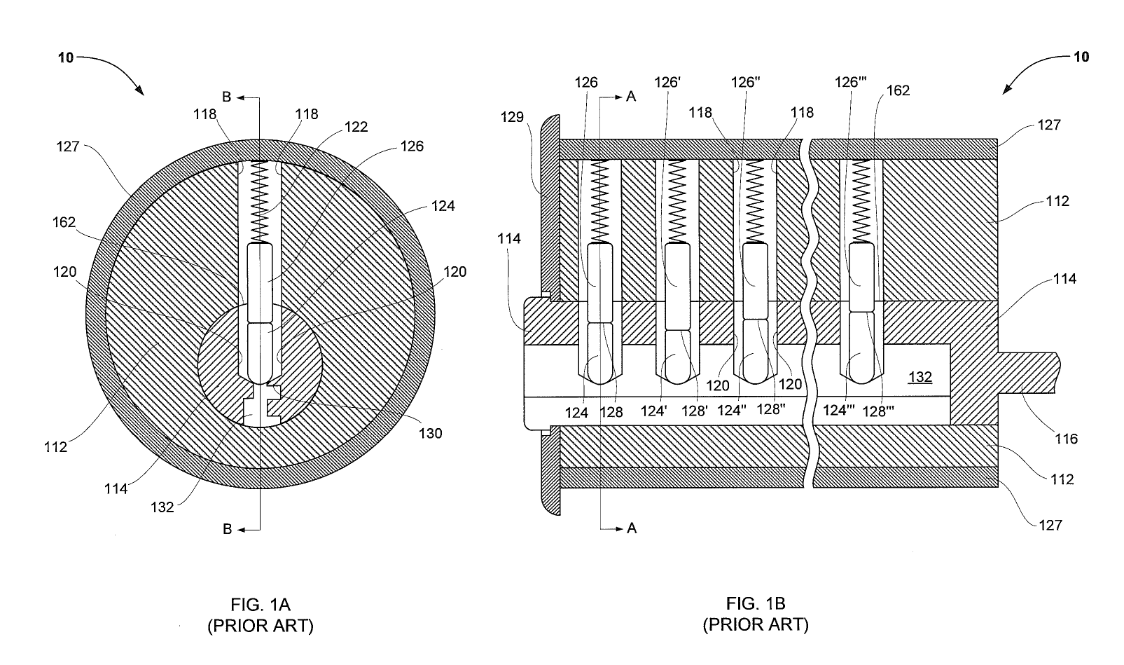

Turning now to FIGS. 1A, 1B, an example of one type of conventional pin tumbler lock is shown generally at 10 in transverse and lengthwise sectional views. The lock includes a cylinder plug 114 received in and rotatable within a housing 112. The interface 162 between the outer surface of the cylinder plug 114 and the housing 112 is referred to as the shear line. The cylinder plug includes a keyway 132 opening at one end, into which a key can be inserted. At the opposite end of the cylinder plug is an arm 116 which is connected to a cam or a lever which operates to move the bolt when the cylinder plug is rotated from a locked to an unlocked position. Passages 118 (four are shown: 118, 118′, 118″, 118′″) are formed in the housing 112, and corresponding passages 120 (120, 120′, 120″, 120′″) are formed in the cylinder plug. A jacket 127 encloses the housing 112 and covers the outer ends of the passages 118, and a faceplate 129 covers the face of the lock. The passages are arranged so that the passages in the cylinder plug are aligned with the passages in the housing when the cylinder plug is in a locked position, as FIGS. 1A, 1B illustrate. Situated in, and slidably moveable in, each aligned pair of passages is a tumbler, or pin set, including (in the example shown) a key pin 124 (124, 124′, 124″, 124′″) and a drive pin 126 (126, 126′, 126″, 126′″). Also within an outer portion of each passage 118 is a spring 122 which serves to bias the pin set toward the keyway 132. Accordingly, when the cylinder plug is in a locked position, and no key is inserted, as shown in FIGS. 1A, 1B, under the bias of the spring each drive pin abuts the corresponding key pin at a split 128 (128, 128′, 128″, 128′″), and the inner end of the key pin rests against a stop 130. And, when the cylinder plug is in a locked position and no key is inserted the split is situated inwardly from the shear line, and the drive pin is dimensioned so that it crosses the shear line 162, preventing rotation of the cylinder plug.

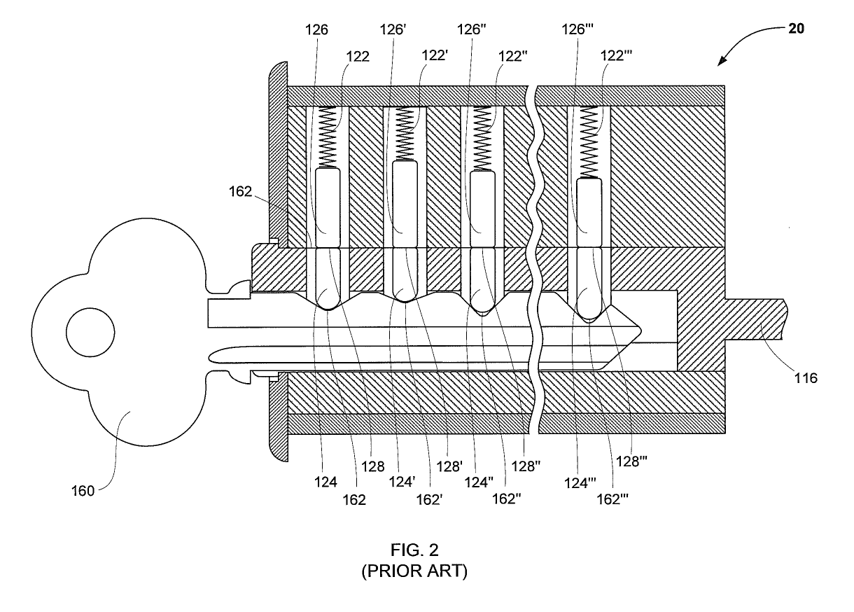

A lock as shown in FIGS. 1A, 1B, may be operated by insertion of a properly cut key 160 in the keyway 132, as shown generally at 20 in FIG. 2. The rounded lower ends 162, 162′, 162″, 162′″ of the key pins slide over the bumps on the key blade as the key is inserted, causing the pin sets to move against the spring bias up and down in the passages; and, when the key has been fully inserted, the lower ends of the key pins rest against the cuts in the key. The key pins are of various lengths, and a properly cut key raises each pin set to a level that brings the split 128 (128, 128′, 128″, 128′″) into alignment with the shear line 162. This allows the cylinder plug to be rotated to an unlocked position, operating the bolt (not shown).

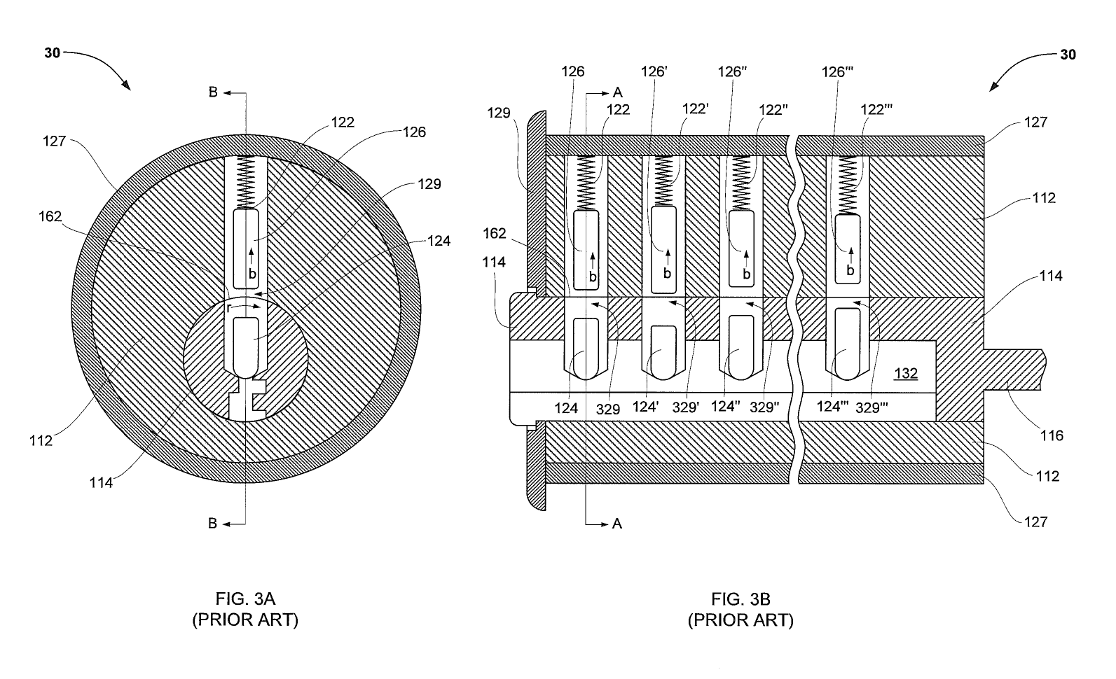

As is well known, pin tumbler locks of this sort can be opened by “bumping” or “snapping”. The principle of bumping is illustrated in FIGS. 3A, 3B. A device (not shown in the FIGs.) is inserted into the keyway and then activated to transfer impulse energy to the key pins. The momentum imparted to the key pins is transferred to the drive pins; the key pins remain generally in place against the stop, while the drive pins move away from the key pins, as illustrated by the arrows b, compressing the biasing springs 122 and for a brief interval opening a gap 329 (329, 329′, 329″, 329′″) between the usually-abutting pins. At some point the biasing springs stop the movement of the drive pins and urge them back against the key pins. But if a torque is applied to the cylinder plug during the interval when the gap traverses the shear line, the cylinder plug can be rotated and the lock can be opened, as indicated by the arrow r in FIG. 3A.

According to the invention, means are provided for preventing or limiting formation of a gap during a bumping attempt.

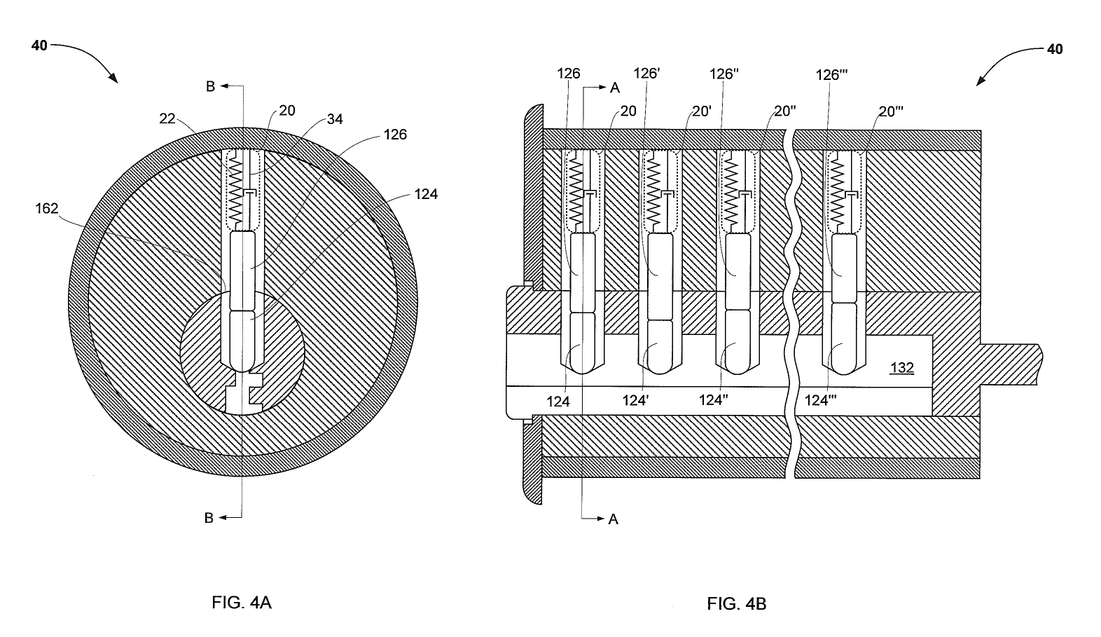

In one embodiment, shown by way of example in FIGS. 4A, 4B, one or more biasing springs are replaced with damped biasing means. In FIGS. 4A, 4B the damped biasing means are indicated symbolically at 20 (20, 20′, 20″, 20′″). The damped biasing means include a spring (or spring function) symbolized at 22, and a damper (or damping function) symbolized at 34. The damper and spring are configured to act in the same direction, but any of a variety of implementations may be suitable. For example, the spring and damper may be next to each other, and operating in parallel. Or, the spring and damper may be in a row lengthwise the passage, and acting in series. Or, the spring may be contained within the damper. Or, the spring function and the damping function can be supplied by the same device.

Without wishing to be limited hereby, the operation of the damped biasing means according to the invention may be explained as follows. As noted above, conventional cylinder locks use biasing springs to hold the tumblers in place. When the tumblers are pushed up the biasing springs push them back with a force equal to a constant times the distance the spring was compressed. This is known as Hooke's Law and is expressed as F=kx where F is equal to force, k is equal to a constant that is a property of the particular spring and x is the distance the spring has been compressed. Accordingly, if one pound of force will compress a spring 1 mm, two pounds of force will compress the spring 2 mm.

Dampers, or shock absorbers, work on a different principle. They resist movement with a force proportional to the velocity, expressed as F=kv where F is force, k is a constant that is a property of a particular damper and v is velocity or speed. Here, if one pound of force will allow movement of one foot per second, it will take two pounds of force on the same damper to move it at two feet per second.

As noted above, picking a lock by bumping requires that the pins be moved at a much higher velocity than normal operation would require. Successful bumping relies on an ability to transfer momentum to the drive pins of the tumblers and drive them upward with enough velocity that they overcome the spring force and travel far enough up the tumbler passage to clear the shear line.

According to this aspect of the invention, a damper operating in concert with a biasing spring permits normal operation of the lock, using the standard key, while forestalling attempts to open the lock by bumping. The damping elements provide a great deal of counter force at high velocity, slowing the drive pins quickly and allowing the springs to push them back before they clear the shear line. Normal operation of the lock simply requires the insertion of the proper key. The damping element does not interfere because this does not require an especially rapid velocity be imparted to the tumblers and in any case, the insertion of the key provides a constant force whereas bumping depends on an impulse force that lasts but a moment. Therefore it is possible to install a damper with a damping constant low enough to allow normal operation of the lock yet more than high enough to prevent a bumping attack.

A variety of suitable damped biasing means are available. For example, miniature shock absorbers, as may be used in small robots or toy vehicles, may have a suitable damped biasing function. And, for example, an elastomer plug may be suitable. As may be appreciated, the damped biasing means need not entirely prevent a gap appearing between the drive and key pins; it is only necessary that the damped biasing means inhibit gap formation between the drive pin and the key pin, that is, to prevent appearance of a gap at the shear line that would permit rotation of the plug cylinder.

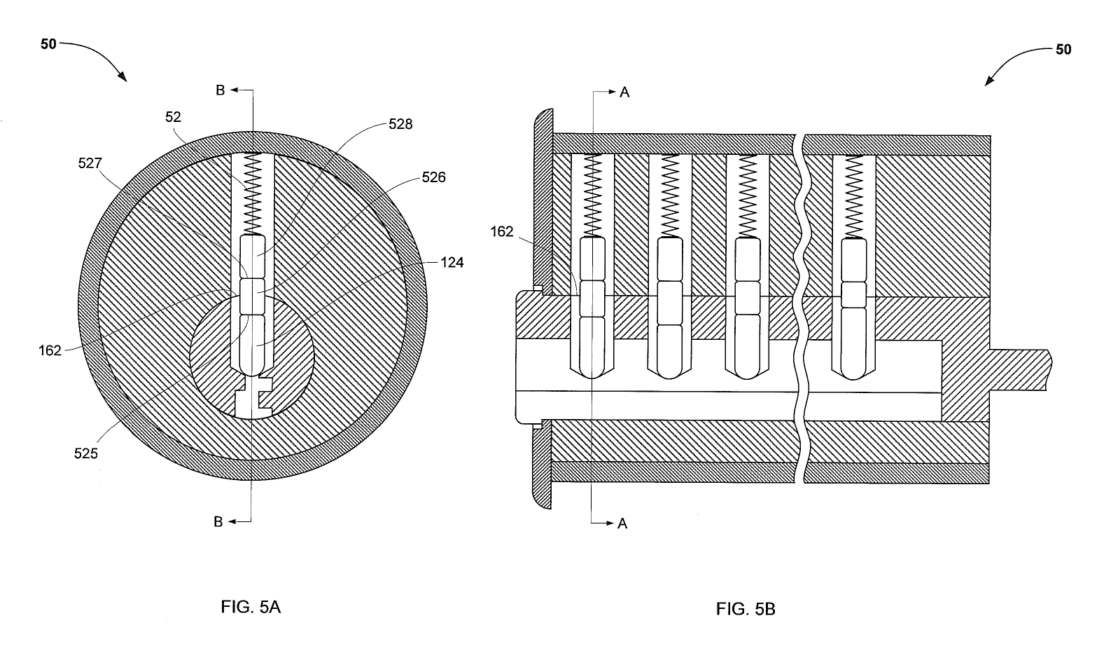

In another embodiment, shown by way of example generally at 50 in FIGS. 5A, 5B, at least one of the tumblers, or pin sets, includes a key pin, a drive pin, and an upper dummy pin. In the example shown in the FIGs., all of the pin sets are so configured, and other features are similar to the configuration shown in FIGS. 1A, 1B. Particularly, each tumbler, or pin set, includes (in the example shown) a key pin 124; a drive pin 526; and a dummy pin 528. Also within an outer portion of each passage is a spring 52 which serves to bias the pin set toward the keyway. Accordingly, when the cylinder plug is in a locked position, and no key is inserted, as shown in FIGS. 5A, 5B, under the bias of the spring each dummy pin 528 abuts the corresponding drive pin 526 at an interface 527, each drive pin 526 abuts the corresponding key pin 124 at a split 525, and the inner end of the key pin rests against a stop. And, when the cylinder plug is in a locked position and no key is inserted the split 525 is situated inwardly from the shear line 162, and the drive pin 526 is dimensioned so that the interface 527 is situated outwardly from the shear line 162; that is, the drive pin 525 crosses the shear line 162, preventing rotation of the cylinder plug.

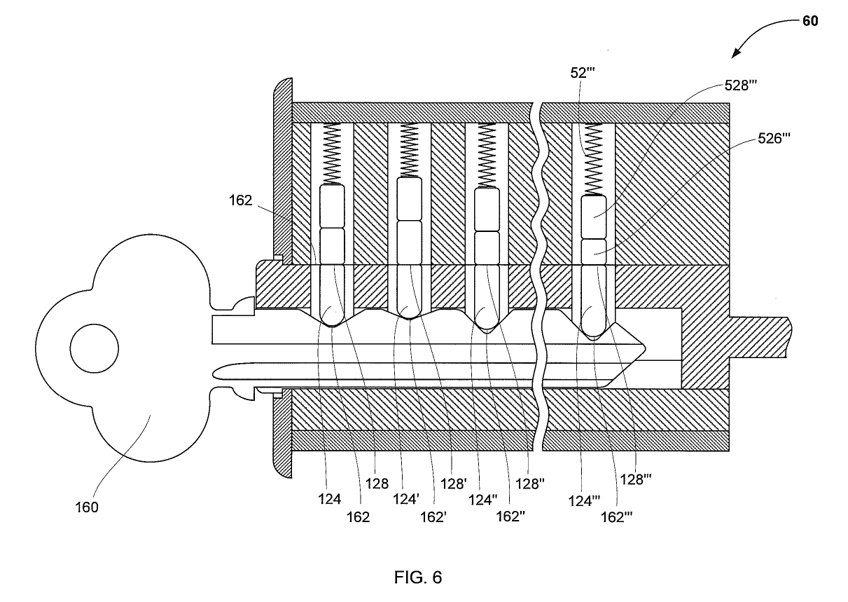

A lock as shown in FIGS. 5A, 5B, may be operated by insertion of a properly cut key 160 in the keyway, as shown generally at 60 in FIG. 6 and as described with reference to FIG. 2. The rounded lower ends 162, 162′, 162″, 162′″ of the key pins slide over the bumps on the key blade as the key is inserted, causing the pin sets to move against the spring bias up and down in the passages; and, when the key has been fully inserted, the lower ends of the key pins rest against the cuts in the key. The key pins are of various lengths, and a properly cut key raises each pin set to a level that brings the split 128 (128, 128′, 128″, 128′″) into alignment with the shear line 162. This allows the cylinder plug to be rotated to an unlocked position, operating the bolt (not shown).

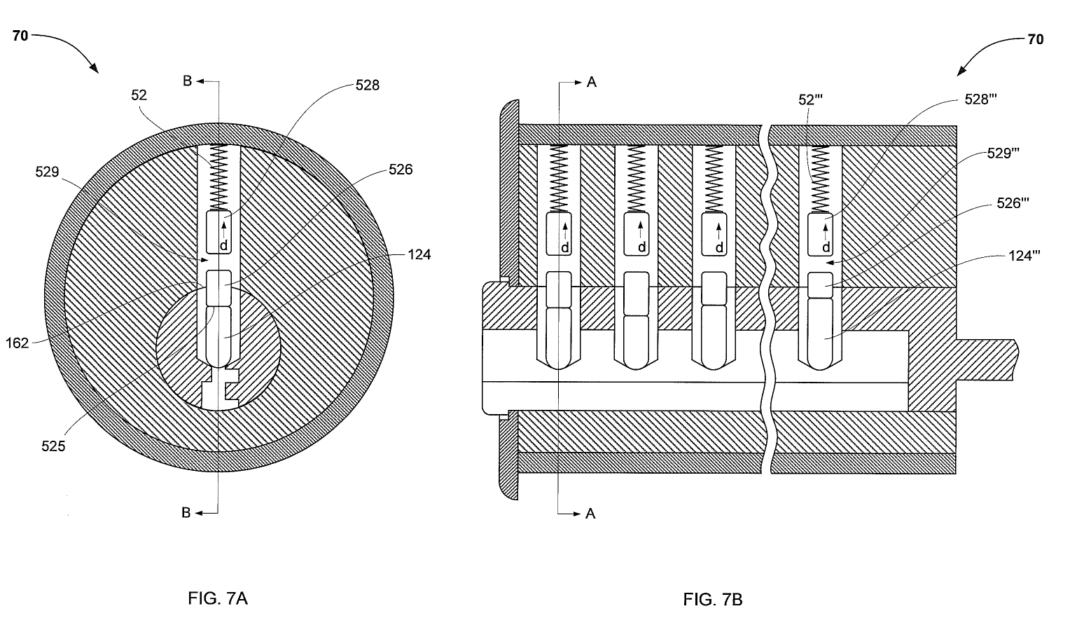

According to this aspect of the invention the dummy pin renders the lock bump resistant, as is illustrated in FIGS. 7A, 7B. Here, when a device (not shown in the FIGs.) is inserted into the keyway and then activated to transfer impulse energy to the key pins, the momentum imparted to the key pins is transferred through the drive pins to the dummy pins; the key pins remain generally in place against the stop, and the drive pins remain generally in place against the key pins, while the dummy pins move away from the drive pins, as illustrated by the arrows d, compressing the biasing springs 52. Here, a gap 529 (529, . . . 529′″) opens for a brief interval not between the key pins and the drive pins, but between the drive pins and the dummy pins. At some point the biasing springs stop the movement of the dummy pins and urge them back against the drive pins. Because the drive pins traverse the shear line 162, rotation of the cylinder plug is prevented. Accordingly, even if a torque is applied to the cylinder plug during the interval when the gap forms, the cylinder plug cannot be rotated and the lock cannot be opened.

The bump resistance may be most effective where substantially all movement is imparted to the dummy pin, and this may be ensured where attention is given to the relative masses of the pins in the pin set. Particularly, the dummy pin may be selected to have approximately the same mass as the corresponding drive pin. Or, the dummy pin may be selected to have a mass approximately equal to the average of the masses of the drive pin and the key pin. As may be appreciated, the relative mass of the pins in the type shown here need not be selected to entirely prevent a gap appearing between the drive and key pins; it is only necessary that sufficient momentum be imparted to the dummy pin to inhibit gap formation between the drive pin and the key pin, that is, to prevent appearance of a gap at the shear line that would permit rotation of the plug cylinder.

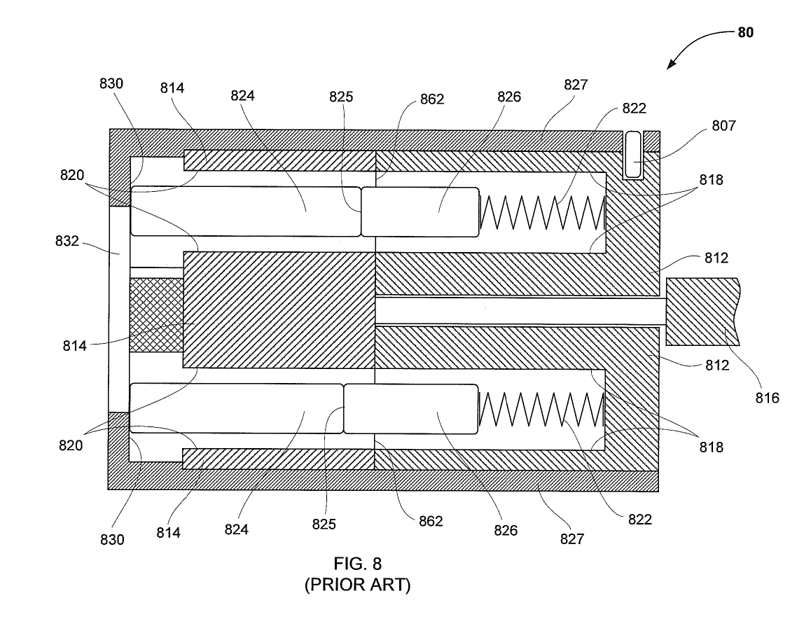

Turning now to FIG. 8, an example of a conventional tubular pin tumbler lock is shown generally at 80 in a lengthwise sectional view. The lock includes a cylinder plug 814 and a housing 812 received within a lock casing 827. The housing 812 is prevented from rotating within the lock casing by (in this example) a pin 807; the cylinder plug 814 is rotatable within the lock casing, and is arranged in rotationally sliding contact with a face surface of the housing 812. The face surface of the housing defines a shear line 862. The cylinder plug 814 includes a shallow circular key opening 832 at one end, into which a tubular key can be inserted. At the opposite end the cylinder plug 814 is connected to an arm 816 which is connected to a cam or a lever which operates to move the bolt when the cylinder plug is rotated from a locked to an unlocked position. Passages 818 are formed in the housing 812, and corresponding passages 820 are formed in the cylinder plug. Two sets of passages are shown; typically there are six or eight such passages. The passages are arranged so that the passages in the cylinder plug are aligned with the passages in the housing when the cylinder plug is in a locked position, as FIG. 8 illustrates. Situated in, and slidably moveable in, each aligned pair of passages is a tumbler, or pin set, including (in the example shown) a key pin 824 and a drive pin 826. Also within an outer portion of each passage 818 is a spring 822 which serves to bias the pin set toward the key opening 832. Accordingly, when the cylinder plug is in a locked position, and no key is inserted, as shown in FIG. 8, under the bias of the spring each drive pin abuts the corresponding key pin at a split 825, and the inner end of the key pin rests against a rim 830 of the lock casing. And, when the cylinder plug is in a locked position and no key is inserted the split is situated away from the shear line toward the key opening, and the drive pin is dimensioned so that it crosses the shear line 862, preventing rotation of the cylinder plug.

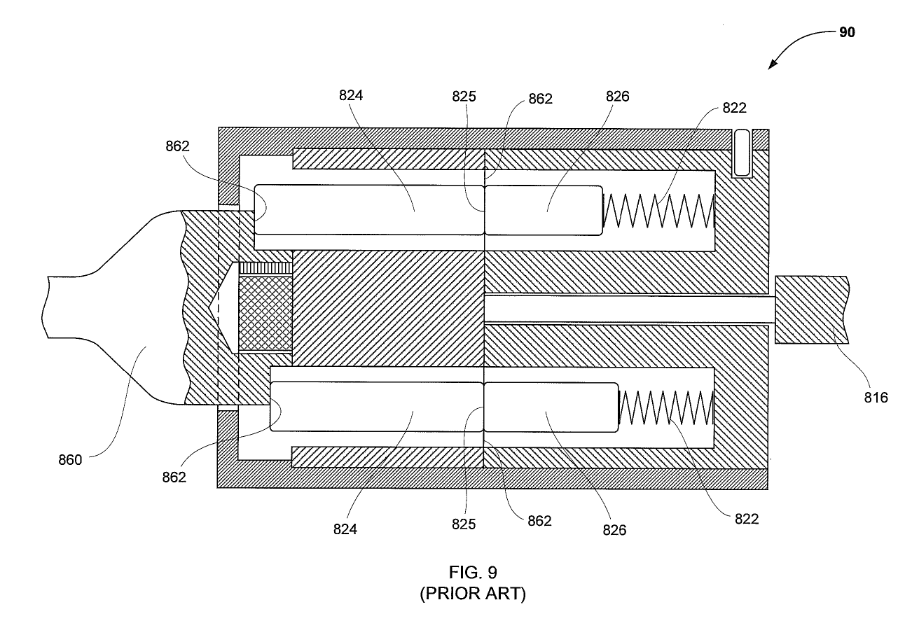

A lock as shown in FIG. 8 may be operated by insertion of a properly cut tubular key 860 in the key opening 832, as shown generally at 90 in FIG. 9. As the key is pressed into the key opening, the cut sectors on the rim of the key press against the ends 862 of the key pins, causing the pin sets to move against the spring bias within the passages. The key pins are of various lengths, and a properly cut key when fully inserted raises each pin set to a level that brings the split 825 into alignment with the shear line 862. This allows the cylinder plug to be rotated to an unlocked position, operating the bolt (not shown).

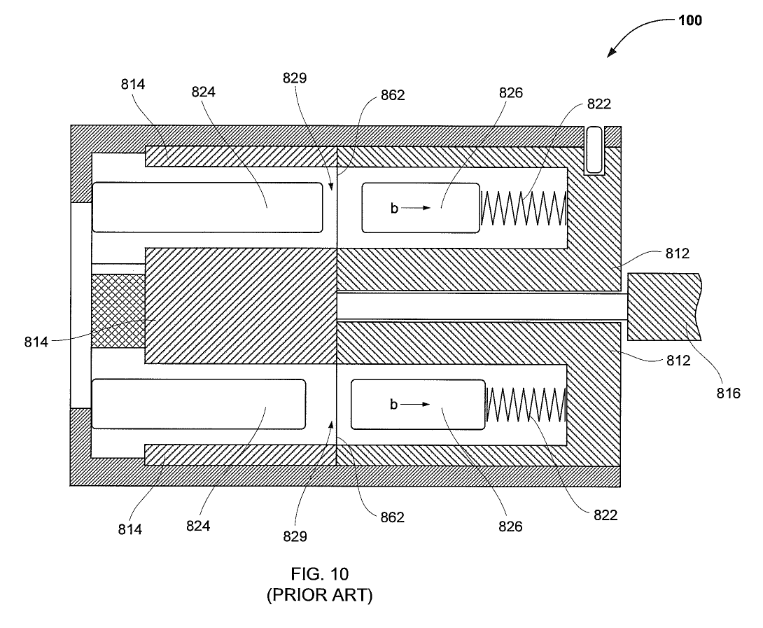

As is well known, pin tumbler locks of this sort can be opened by “bumping”. The principle of bumping is illustrated in FIG. 10. A device (not shown in the FIGs.) is inserted into the key opening and then activated to transfer impulse energy to the key pins. The momentum imparted to the key pins is transferred to the drive pins; the key pins remain generally in place against the stop, while the drive pins move away from the key pins, as illustrated by the arrows b, compressing the biasing springs 822 and for a brief interval opening a gap 829 between the usually-abutting pins. At some point the biasing springs stop the movement of the drive pins and urge them back against the key pins. But if a torque is applied to the cylinder plug during the interval when the gap traverses the shear line, the cylinder plug can be rotated and the lock can be opened.

According to the invention, means are provided for preventing or limiting formation of a gap during a bumping attempt.

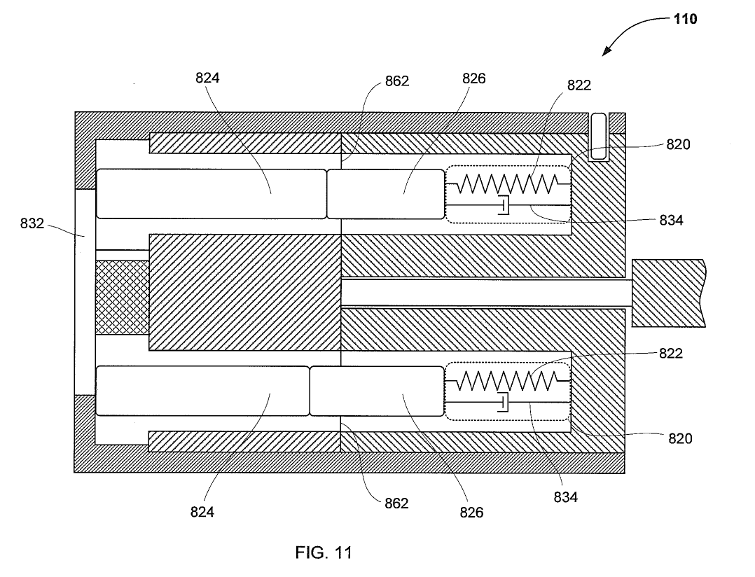

In one embodiment, shown by way of example generally at 110 in FIG. 11, one or more biasing springs are replaced with damped biasing means. In FIG. 11 the damped biasing means are indicated symbolically at 820. The damped biasing means include a spring (or spring function) symbolized at 822, and a damper (or damping function) symbolized at 834. The damper and spring are configured to act in the same direction, but any of a variety of implementations may be suitable. For example, the spring and damper may be next to each other, and operating in parallel. Or, the spring and damper may be in a row lengthwise the passage, and acting in series. Or, the spring may be contained within the damper. Or, the spring function and the damping function can be supplied by the same device.

A variety of suitable damped biasing means are available. For example, miniature shock absorbers, as may be used in small robots or toy vehicles, may have a suitable damped biasing function. And, for example, an elastomer plug may be suitable. As noted above with reference to the pin tumbler lock of the type shown for example in FIGS. 4A, 4B, the damped biasing means need not entirely prevent a gap appearing between the drive and key pins; it is only necessary that the damped biasing means inhibit gap formation between the drive pin and the key pin, that is, to prevent appearance of a gap at the shear line that would permit rotation of the plug cylinder.

The operation of the invention in such embodiments is substantially like that described with reference to FIGS. 4A, 4B; and similar damped bias means may be suitable.

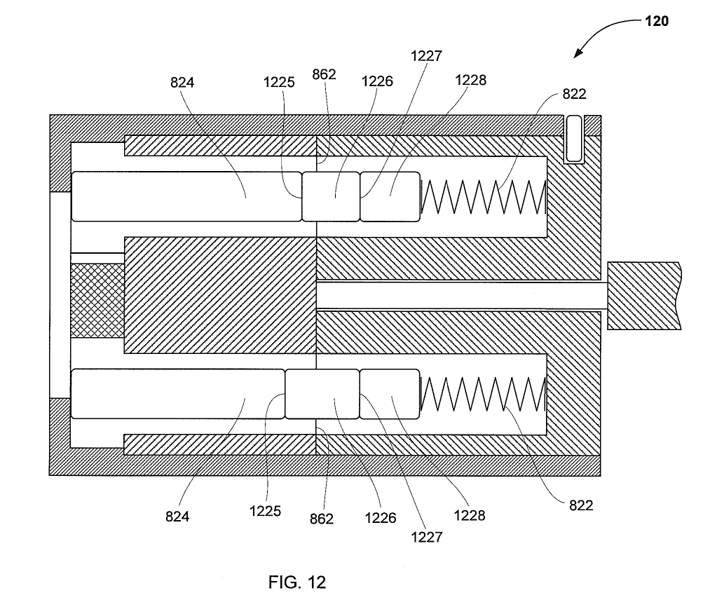

In another embodiment, shown by way of example generally at 120 in FIG. 12, at least one of the tumblers, or pin sets, includes a key pin, a drive pin, and a dummy pin. In the example shown in the FIG., two pin sets are so configured, and other features are similar to the configuration shown in FIG. 8. Particularly, each tumbler, or pin set, includes (in the example shown) a key pin 824; a drive pin 1226; and a dummy pin 1228. Also within an outer portion of each passage is a spring 822 which serves to bias the pin set toward the key opening. Accordingly, when the cylinder plug is in a locked position, and no key is inserted, as shown in FIG. 12, under the bias of the spring each dummy pin 1228 abuts the corresponding drive pin 1226 at an interface 1227, each drive pin 1226 abuts the corresponding key pin 824 at a split 1225, and the front end of the key pin rests against a stop. And, when the cylinder plug is in a locked position and no key is inserted the split 1225 is situated frontwardly from the shear line 862, and the drive pin 1226 is dimensioned so that the interface 1227 is situated outwardly from the shear line 862; that is, the drive pin 1225 crosses the shear line 862, preventing rotation of the cylinder plug.

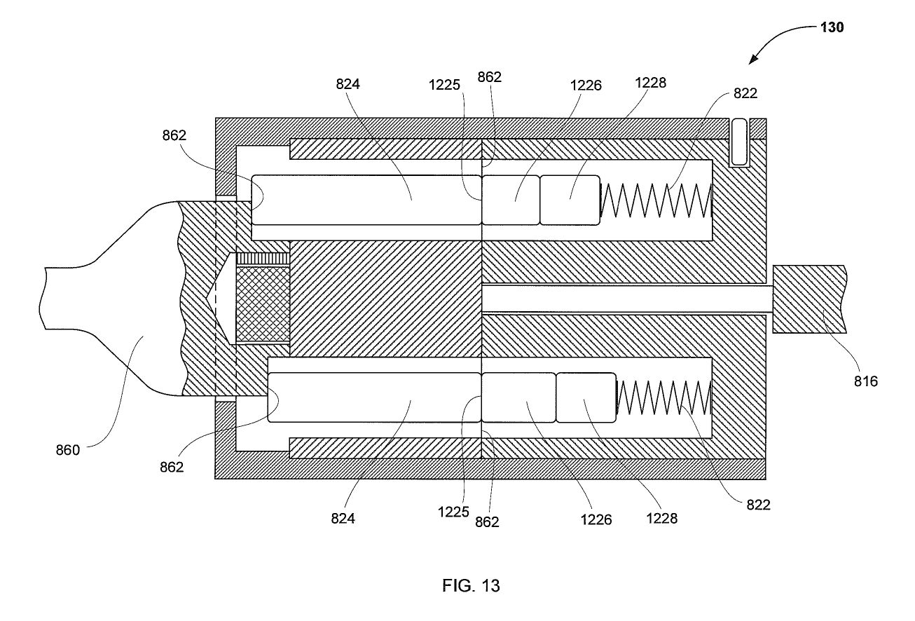

A lock as shown in FIG. 12, may be operated by insertion of a properly cut key 860 in the key opening, as shown generally at 130 in FIG. 13 and as described with reference to FIG. 9. As the key is pressed into the key opening, the cut sectors on the rim of the key press against the ends 862 of the key pins, causing the pin sets to move against the spring bias within the passages. The key pins are of various lengths, and a properly cut key when fully inserted raises each pin set to a level that brings the split 1225 into alignment with the shear line 862. This allows the cylinder plug to be rotated to an unlocked position, operating the bolt (not shown).

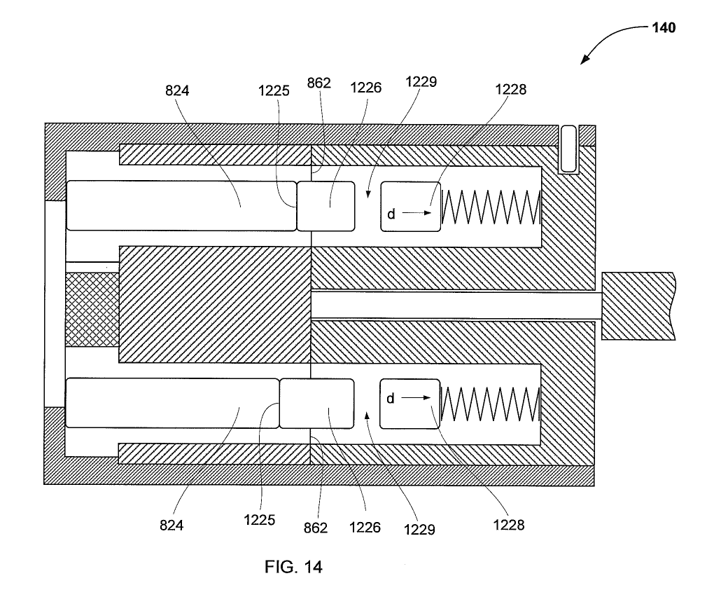

According to this aspect of the invention the dummy pin renders the lock bump resistant, as is illustrated in FIG. 14. Here, when a device (not shown in the FIGs.) is inserted into the key opening and then activated to transfer impulse energy to the key pins, the momentum imparted to the key pins is transferred through the drive pins to the dummy pins; the key pins remain generally in place against the stop, and the drive pins remain generally in place against the key pins, while the dummy pins move away from the drive pins, as illustrated by the arrows d, compressing the biasing springs 822. Here, a gap 1229 opens for a brief interval not between the key pins and the drive pins, but between the drive pins and the dummy pins. At some point the biasing springs stop the movement of the dummy pins and urge them back against the drive pins. Because the drive pins traverse the shear line 862, rotation of the cylinder plug is prevented. Accordingly, even if a torque is applied to the cylinder plug during the interval when the gap forms, the cylinder plug cannot be rotated and the lock cannot be opened.

The bump resistance may be most effective where substantially all movement is imparted to the dummy pin, and this may be ensured where attention is given to the relative masses of the pins in the pin set. Particularly, the dummy pin may be selected to have approximately the same mass as the corresponding drive pin. Or, the dummy pin may be selected to have a mass approximately equal to the average of the masses of the drive pin and the key pin. As noted above with reference to the pin tumbler lock of the type shown for example in FIGS. 7A, 7B, the relative mass of the pins in the type shown here need not be selected to entirely prevent a gap appearing between the drive and key pins; it is only necessary that sufficient momentum be imparted to the dummy pin to inhibit gap formation between the drive pin and the key pin, that is, to prevent appearance of a gap at the shear line that would permit rotation of the plug cylinder.

### EXAMPLES

### Damped Spring Embodiments

### Determination of Necessary Damping

The damping coefficient necessary for a lock to be bump resistant depends upon: the mass of the pin in question, the spring rate of the biasing spring, and the maximum distance that the pin can be allowed to travel. The derivation of the governing equation is determined from the governing principle of Conservation of Energy. In an idealized case that equation states that the kinetic energy of the pin the moment after it has been launched into movement by the bump key is equal to the potential energy of the spring at the point when the pin has reached the maximum allowable travel plus the energy that has been dissipated by the damper. We write the equation as follows:

KE_{INITIAL}=PE_{FINAL}+Q(damping) [1]

Substituting in the values for KE, PE and Q we get the following:

$$\frac{m \cdot {v}_{INITIAL}^{2}}{2} = \frac{k \cdot {x}_{MAX}^{2}}{2} + {\int }_{x = 0}^{x = {x}_{MAX}} c \cdot v ( x ) d x , \qquad [ 2 ]$$

where m is the mass of the pin, V_{INITIAL} is the velocity imparted to the pin by the bump key, X_{MAX} is the maximum allowable travel of the pin, c is the damping coefficient and v(x) is the functional representation of the pin's velocity in the system.

Solving equation [2] for c tells us that the minimum required damping is given by:

$$c = \frac{m \cdot {v}_{INITIAL}}{{x}_{MAX}} - \frac{k \cdot {x}_{MAX}}{{v}_{INITIAL}} . \qquad [ 3 ]$$

In practice the second part of equation [3] is negligible in relation to the first part because the spring force is entirely too small to prevent bumping, so equation [3] may be simplified as:

$$c = \frac{m \cdot {v}_{INITIAL}}{{x}_{MAX}} . \qquad [ 4 ]$$

Alternatively, the necessary damping can be derived by using vibration theory. Taking as an assumption that the system is overdamped (it will actually be massively overdamped) we can write the equation of motion as:

$$\begin{matrix}m \cdot \frac{d v}{d t} + c \cdot v = 0 ; \\ thus \text{:} & [ 5 ] \\ v ( t ) = {v}_{INITIAL} \cdot {e}^{- ( \frac{c \cdot t}{m} )} , \\ and \text{:} & [ 6 ] \\ x ( t ) = \frac{m}{c} \cdot {v}_{INITIAL} \cdot ( 1 - {e}^{- ( \frac{c \cdot t}{m} )} ) , & [ 7 ]\end{matrix}$$

so x_{MAX} occurs when v=0, which means that:

$$\begin{matrix}{x}_{MAX} = \frac{m \cdot {v}_{INITIAL}}{c} , \\ or \text{:} & [ 8 ] \\ c = \frac{m \cdot {v}_{INITIAL}}{{x}_{MAX}} . & [ 9 ]\end{matrix}$$

Typical values for X_{MAX} might vary between 1 and 9 thousandths of an inch and typical values for the initial velocity might be 1, 5, 10, or 20 m/s. By way of example, for a spring constant of 20 N/m and pin mass of 3×10⁻⁴ kg (0.3 gram) we would obtain minimum required damping coefficients for various pin travel distances as shown in the following Table I.

TABLE I

| | 2.54 | 5.08 | 7.62 | 10.16 | 12.7 | 15.24 | 17.78 | 20.32 | 22.86 |
|---|---|---|---|---|---|---|---|---|---|
| | E-5m | E-5m | E-5m | E-5m | E-5m | E-5m | E-5m | E-5m | E-5m |
| 1 m/s | 11.81 kg/s | 5.9 kg/s | 3.94 kg/s | 2.95 kg/s | 2.362 kg/s | 1.97 kg/s | 1.69 kg/s | 1.48 kg/s | 1.31 kg/s |
| 5 m/s | 59.06 kg/s | 29.53 kg/s | 19.7 kg/s | 14.75 kg/s | 11.81 kg/s | 9.85 kg/s | 8.45 kg/s | 7.4 kg/s | 6.55 kg/s |
| 10 m/s | 118.1 kg/s | 59.05 kg/s | 39.4 kg/s | 29.5 kg/s | 23.62 kg/s | 19.7 kg/s | 16.9 kg/s | 14.8 kg/s | 13.1 kg/s |
| 20 m/s | 236.2 kg/s | 118.1 kg/s | 78.8 kg/s | 59.0 kg/s | 47.24 kg/s | 39.4 kg/s | 33.8 kg/s | 29.6 kg/s | 26.2 kg/s |

### Dummy Pin Embodiments

### Determination of Necessary Pin Masses

The necessary masses for optimal operation of dummy pin embodiments are determined from Conservation of Energy and Conservation of Momentum principles. These theories state that in an ideal case of two bodies colliding in a perfectly elastic collision, the energy lost from one body is gained by the other body and that the momentum lost from one body is gained by the other body. The equations are written as follows:

m₁·v₁=m₂·v₂ [10]

and:

$$\frac{1}{2} \cdot {m}_{1} \cdot {( {v}_{1} )}^{2} = \frac{1}{2} \cdot {m}_{2} \cdot {( {v}_{2} )}^{2} . \qquad [ 11 ]$$

In an idealized case in the dummy pin embodiments each lower pin transfers all of its energy and momentum to the pin above. This can be effected for example, by appropriate selection of the relative masses of the pins in the pin set. For example, the mass of the dummy pin may be at least as great as the greater of the mass of the key pin or the mass of the drive pin. That is, where the mass of the key pin is greater or equal to the mass of the drive pin, the mass of the dummy pin is greater than or equal to the mass of the key pin; and, where the mass of the drive pin is greater than or equal to the mass of the key pin, the mass of the dummy pin is greater than or equal to the mass of the drive pin. Or, for example, going upward from the key to the dummy pin, the mass of each pin may be equal to or greater than the pin below; that is, mass_{KEY PIN}≦mass_{DRIVE PIN}≦mass_{DUMMY PIN}.

As may be appreciated, the lock may be rendered bump resistant according to a dummy pin embodiment in a less than idealized case, in which slightly less than all of the energy and momentum of a pin is transferred to the pin above. To effect bump resistance, the relative masses of the pins must be such that when momentum is imparted by the key pin to the drive pin, movement of the drive pin is limited so that the bottom end of the drive pin does not reach or pass the shear line, or—if the bottom end of the drive pin reaches or passes the shear line—it does so for such a short time interval that rotation of the cylinder plug is effectively blocked.

Other embodiments are within the claims. For example, bump resistance may be effected by providing the bump resistance means in fewer than all the passages and, in some configurations, bump resistance may be effected by providing the bump resistance means in only one of the passages.

I claim:

1. A pin tumbler lock having a cylinder plug rotatable about an axis in relation to a housing, the cylinder plug and the housing defining a shear line between them, the lock comprising at least one passage containing a pin set including a key pin, a drive pin, and a dummy pin, wherein the key pin and the drive pin are dimensioned so that when the lock is at rest the drive pin crosses the shear line.

2. The lock of claim 1 wherein the passage is disposed generally perpendicular to the rotational axis.

3. The lock of claim 1 wherein the passage is disposed generally parallel to the rotational axis.

4. The lock of claim 1 wherein the masses of the pins are selected so that when momentum is imparted by the key pin to the drive pin, movement of the drive pin is limited so that if the bottom end of the drive pin reaches or passes the shear line, it does so for a time interval insufficient to permit rotation of the cylinder plug.

5. The lock of claim 1 wherein the masses of the pins are selected so that when momentum is imparted by the key pin to the drive pin, movement of the drive pin is limited so that the bottom end of the drive pin does not reach or pass the shear line.

6. The lock of claim 1 wherein the mass of the dummy pin is at least as great as the greater of the mass of the key pin or the mass of the drive pin.

7. The lock of claim 1 wherein the mass of the drive pin is at least as great as the mass of the key pin, and the mass of the dummy pin is at least as great as the mass of the drive pin.

7. The lock of claim 1 wherein the mass of the key pin is at least as great as the mass of the drive pin, and the mass of the dummy pin is at least as great as the mass of the key pin.

8. The lock of claim 1 wherein the mass of the key pin is less than or equal to the mass of the drive pin, which is less than or equal to the mass of the dummy pin.

9. The lock of claim 1 wherein a first one of said pins having greater mass than a second one of said pins has a greater volume than the second one of said pins.

10. The lock of claim 1 wherein a first one of said pins having greater mass than a second one of said pins has a greater density than the second one of said pins.

11. The lock of claim 1 wherein a first one of said pins having greater mass than a second one of said pins comprises a material having a greater density than the second one of said pins.

12. A pin tumbler lock comprising at least one passage containing damped biasing means operable to urge the pin set toward a key opening or keyway.

13. A kit for modification of a pin tumbler lock, the kit comprising at least one damped biasing means configured and dimensioned to operate within a passage of the lock.

14. A kit for modification of a pin tumbler lock having a cylinder plug rotatable in relation to a housing, the cylinder plug and the housing defining a shear line between them, the kit comprising at least one pin set including a key pin, a drive pin, and a dummy pin, configured and dimensioned to operate within a passage of the lock, the key pin and the drive pin being dimensioned so that when the lock is at rest the drive pin crosses the shear line.

15. A method for improving resistance to attack in a pin tumbler lock having at least one passage containing a pin set and a spring, by replacing the spring in at least one said passage with damped biasing means.

16. A method for improving the resistance to attack in a pin tumbler lock having at least one passage containing a pin set including a drive pin, by replacing the drive pin with a substitute drive pin and a dummy pin.
